(19) United States
(12) Patent Application Publication
(10) Pub. No.: US 2022/0040845 A1
(43) Pub. Date: Feb. 10, 2022

(54) SLIDER-TYPE WIRE DRIVER FOR UNDERACTUATION AND GLOVE-TYPE WEARABLE ROBOT COMPRISING SAME

(71) Applicant: SEOUL NATIONAL UNIVERSITY R&DB FOUNDATION, Seoul (KR)

(72) Inventors: Kyu-Jin Cho, Seoul (KR); Byung-Chul Kim, Seoul (KR); Hyung-Min Choi, Seoul (KR)

(73) Assignee: SEOUL NATIONAL UNIVERSITY R&DB FOUNDATION, Seoul (KR)

(21) Appl. No.: 17/506,689

(22) Filed: Oct. 21, 2021

Related U.S. Application Data
(63) Continuation of application No. PCT/KR2020/005275, filed on Apr. 22, 2020.

(30) Foreign Application Priority Data
Apr. 22, 2019 (KR) 10-2019-0046621
Sep. 10, 2019 (KR) 10-2019-0112021

(51) Int. Cl. B25J 9/00; B25J 9/10; B25J 9/12; A61H 1/02

(52) U.S. Cl. CPC B25J 9/0006; B25J 9/1045; A61H 2201/1664; A61H 1/0288; A61H 2201/165; B25J 9/126

(57) ABSTRACT

Provided are a slider-type wire driver for under-actuation and a glove-type wearable robot including the same. In particular, provided are a slider-type wire driver for under-actuation that has a structure suitable for actuating a robot in an under-actuation manner, has a simple structure, and enables effective operation, and a glove-type wearable robot including the same. A slider-type wire driver for under-actuation and a glove-type wearable robot including the same according to embodiments of the present disclosure, can effectively reduce friction between the tendon and the surrounding structure thereof, facilitating the operation of the under-actuation robot and improving the lifespan thereof. In addition, in the case of the slider-type wire driver for under-actuation and a glove-type wearable robot including the same according to the present disclosure, an actuator that applies tension to the tendon for under-actuation can be manufactured at a low price.

This application is a continuation of PCT International Application No. PCT/KR2020/005275, filed on Apr. 22, 2020, which claims priority under 35 U.S.C. § 119(a) to Korean Patent Application No. 10-2019-0046621, filed on Apr. 22, 2019, and Korean Patent Application No. 10-2019-0112021, filed on Sep. 10, 2019. Each of the above application(s) is hereby expressly incorporated by reference, in its entirety, into the present application.

### TECHNICAL FIELD

The present disclosure relates to a slider-type wire driver for under-actuation and a glove-type wearable robot having the same, and in particular, to a slider-type wire driver for under-actuation that has a structure suitable for actuating a robot in an under-actuation manner, has a simple structure, and enables effective operation, and a glove-type wearable robot including the same.

### BACKGROUND ART

Conventionally, a method of transmitting power by applying tension to a tendon to actuate a robot, has been widely used.

Recently, under-actuation-type robot actuation in which the number of actuators used for actuating a robot is less than the number of motions or degrees of freedom implemented by the actual robot, is used a lot.

When a robot is actuated using a tendon in such an under-actuation method, it is important to effectively manage the frictional force generated by the tendon. When it is configured to cause slip between the tendon and its surrounding components, due to the tension applied to the tendon and the friction force generated by the movement of the tendon, the motion may not be made smoothly or the robot is worn and damaged.

### DESCRIPTION OF EMBODIMENTS

### Technical Problem

One or more embodiments of the present disclosure provides a slider-type wire driver for under-actuation that minimizes the friction force generated by the tendon and lowers the manufacturing cost due to a simple structure, and a glove-type wearable robot including the same.

### Solution to Problem

According to one or more embodiments, slider-type wire driver for under-actuation includes: a support body; a guide member provided on a support body to extend in a longitudinal direction of the guide member; a slider provided on the guide member to be able to move linearly along the guide member; an actuation unit provided on the support body to move the slider relative to the guide member; and a follower unit including at least one follower bearing provided on the slider, a follower pulley provided on the follower bearing, and a follower tendon provided to be wound around the follower pulley and having opposite ends connected to a device for actuation.

According to one or more embodiments, a glove-type wearable robot comprising a slider-type wire driver for under-actuation includes: a support body; a guide member provided on a support body to extend in a longitudinal direction of the guide member; a slider provided on the guide member to be able to move linearly along the guide member; an actuation unit provided on the support body to move the slider relative to the guide member; and a follower unit including at least one follower bearing provided on the slider, a follower pulley provided on the follower bearing, and a follower tendon provided to be wound around the follower pulley and having opposite ends connected to a device for actuation; and a glove member that is formed in the form of a wearable glove and operates by being connected to each of the opposite ends of the follower tendon of the follower unit to each other.

### ADVANTAGEOUS EFFECTS OF DISCLOSURE

A slider-type wire driver for under-actuation and a glove-type wearable robot including the same according to embodiments of the present disclosure, can effectively reduce friction between the tendon and the surrounding structure thereof, facilitating the operation of the under-actuation robot and improving the lifespan thereof.

In addition, in the case of the slider-type wire driver for under-actuation and a glove-type wearable robot including the same according to the present disclosure, an actuator that applies tension to the tendon for under-actuation can be manufactured at a low price.

### BRIEF DESCRIPTION OF DRAWINGS

FIG. 1 shows a perspective view of a slider-type wire driver for under-actuation according to an embodiment of the present disclosure.

FIG. 2 shows a plan view of the slider-type wire driver for under-actuation illustrated in FIG. 1.

FIG. 3 shows a side view of the slider-type wire driver for under-actuation illustrated in FIG. 1.

FIG. 4 illustrates a glove member of a glove-type wearable robot including a slider-type wire driver for under-actuation, using a slider-type wire driver for under-actuation of the present disclosure illustrated in FIGS. 1 to 3.

### MODE OF DISCLOSURE

Hereinafter, a slider-type wire driver for under-actuation and a glove-type wearable robot including the same according to the present disclosure will be described in detail with reference to the accompanying drawings.

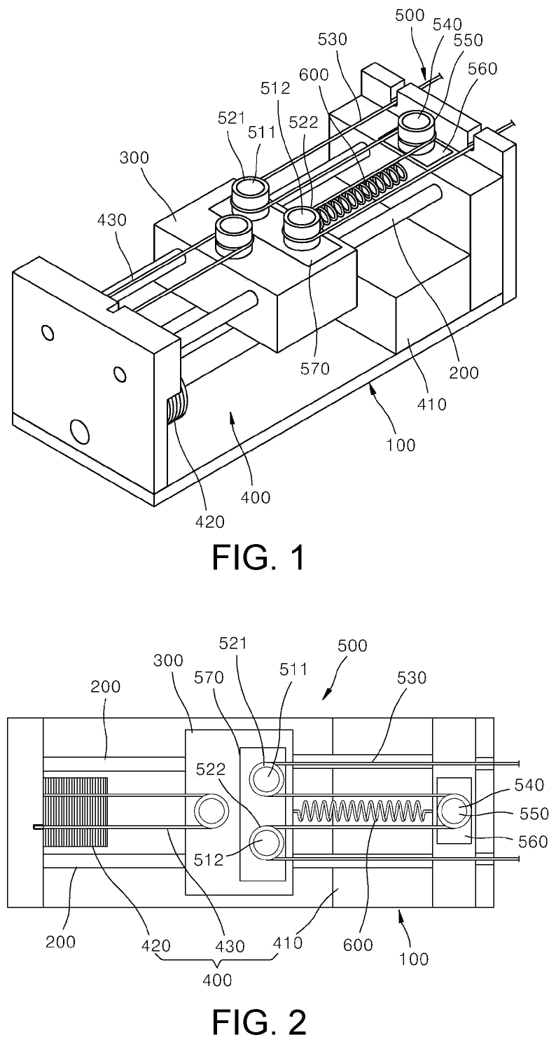

First, referring to FIGS. 1 to 3, a slider-type wire driver for under-actuation according to an embodiment of the present disclosure will be described.

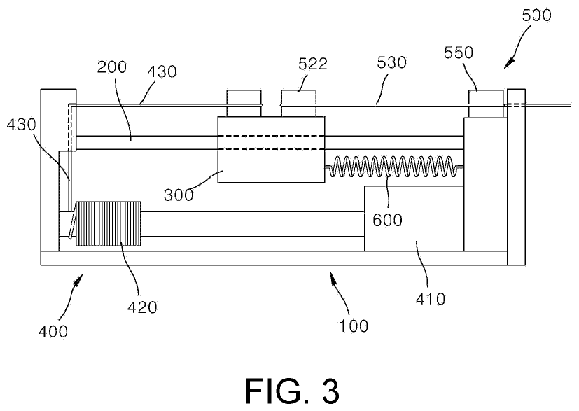

FIG. 1 shows a perspective view of a slider-type wire driver for under-actuation according to an embodiment of the present disclosure, FIG. 2 shows a plan view of the slider-type wire driver for under-actuation illustrated in FIG. 1, and FIG. 3 shows a side view of the slider-type wire driver for under-actuation illustrated in FIG. 1.

Referring to FIGS. 1 to 3, a slider-type wire driver for under-actuation according to an embodiment of the present disclosure includes a support body 100, a guide member 200, a slider 300, and an actuation unit 400, and a follower unit 500.

The support body 100 may be formed in a shape capable of supporting the guide member 200 to be described later.

The guide member 200 may be formed in the form of two cylinders arranged parallel to each other as illustrated in FIG. 1. The guide member 200 may extend in the longitudinal direction thereof and may be fixed onto a support member.

The slider 300 may be provided on the guide member 200 and may be able to slide along the guide member 200.

The actuation unit 400 may be provided on the support body 100 and may move the slider 300 along the guide member 200. In the present embodiment, the actuation unit 400 may include an actuation motor 410, an actuation pulley 420, and an actuation tendon 430. The actuation motor 410 may be provided on the support body 100 and operates according to control signals. The actuation pulley 420 may be connected to the actuation motor 410 to rotate according to the operation of the actuation motor 410. One end of the actuation tendon 430 may be connected to the actuation pulley 420 and the other end thereof may be connected to the slider 300. In the present embodiment, as illustrated in FIG. 1, the actuation tendon 430 may be provided to be fixed onto the support body 100 via a bearing provided in the slider 300.

When the actuation pulley 420 is rotated by operating the actuation motor 410, the actuation tendon 430 is wound around the actuation pulley 420 and the slider 300 is pulled. The slider 300 slides along the guide member 200 and moves in the direction the actuation tendon 430 pulls. A follower tendon 530 may be connected to the slider 300 through follower pulleys 521 and 522, not fixed directly onto the slider 300. Accordingly, the follower tendon 530 may be pulled by the slider 300 while slip thereof with respect to the slider 300 is allowed. Such a structure can be effectively used in the under-actuation type robot according to the present disclosure.

An elastic member 600 may be provided between the support body 100 and the slider 300. The elastic member 600 provides an elastic force to the slider 300 in the direction opposite to the direction in which the slider 300 is moved by the actuation tendon 430. That is, when the force of the actuation motor 410 is removed, the slider 300 which has been moved in one direction by the actuation unit 400, may be moved in the opposite direction by the elastic member 600. In the present embodiment, the elastic member 600 may be in the form of a spring as illustrated in FIGS. 1 and 2. The elastic member 600 in the form of a spring may provide an elastic force to the slider 300 in a direction in which the length thereof is reduced.

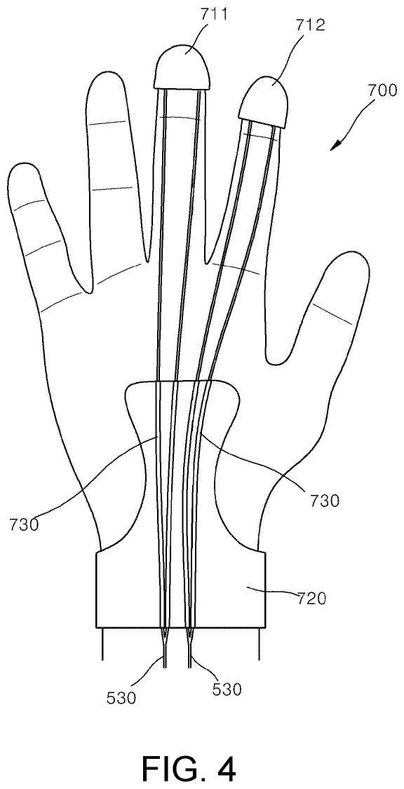

The follower unit 500 may include at least one of follower bearings 511 and 512 and at least one of the follower pulleys 521 and 522, and the follower tendon 530. In the present embodiment, two follower bearings 511 and 512 are provided on the slider 300 as illustrated in FIG. 2. A connecting bearing 540 may be provided on the support body 100. The follower pulleys 521 and 522 may be provided on the follower bearings 511 and 512 and a connection pulley 550 may be provided on the connecting bearing 540. The follower tendon 530 may be provided such that opposite ends thereof are connected to a device for actuation through the follower pulleys 521 and 522 and the connection pulley 550. In the present embodiment, the follower tendon 530 may be connected to a glove member 700 having the same structure as illustrated in FIG. 4.

The follower bearings 511 and 512 may be fixed onto a follower plate 570 as illustrated in FIGS. 1 and 2, and the follower plate 570 may be fixed in such a way that the follower plate 570 is fitted into a groove formed in the upper surface of the slider 300. The connecting bearing 540 may be fixed to a connecting plate 560, and the connecting plate 560 may be fixed in such a way that the connecting plate 560 is fitted into the groove formed in the support body 100.

With this structure, the follower bearings 511 and 512 of the follower unit 500 may be provided detachably to the slider 300.

FIG. 4 illustrates the glove member 700 as an example of an under-actuation robot to which the slider-type wire driver for under-actuation of the present disclosure described with reference to FIGS. 1 to 3 is connected. A glove-type wearable robot including a slider-type wire driver for under-actuation according to an embodiment of the present disclosure is configured by connecting the slider-type wire driver for under-actuation illustrated in FIGS. 1 to 3 to the glove member 700 illustrated in FIG. 4.

Referring to FIG. 4, the glove member 700 may include two cap members 711 and 712, a wrist member 720, and a plurality of tube members 730. The glove member 700 may be formed in the form of a glove that can be worn on the user's hand as a whole.

The cap members 711 and 712 may be formed to cover the tip of the finger, and may each be connected to opposite ends of the follower tendon 530. In the present embodiment, the cap members 711 and 712 may be formed so as to cover the tip of the index finger and the tip of the middle finger, respectively. The number of cap members 711 and 712 and the finger covered by the cap members 711 and 712 may vary depending on the situation.

The wrist member 720 is formed to be mounted on the user's wrist. The follower tendon 530 connected to the cap members 711 and 712, may be connected to the follower pulleys 521 and 522 via the wrist member 720.

The tube members 730 may be placed between the cap members 711 and 712 and the wrist member 720 to allow the follower tendon 530 to pass therethrough. The tube members 730 may guide the movement of the follower tendon 530.

Hereinafter, the slider-type wire driver for under-actuation configured as described above and the operation of the glove-type wearable robot including the same will be described.

First, the glove member 700 is worn by the user. As described above, the follower tendon 530 of the follower unit 500 may be connected to the glove member 700. Due to the elastic force of the elastic member 600, the slider 300 is slid to the right based on FIGS. 2 and 3, and the user's finger is straightened.

When the actuation motor 410 of the actuation unit 400 is operated, the actuation pulley 420 rotates. The actuation tendon 430 is wound around the actuation pulley 420 and the slider 300 is pulled to the left. The elastic member 600 is stretched, and the slider 300 is guided by the guide member 200 and slides to the left while moving linearly.

When the slider 300 moves in the direction closer to the actuation unit 400, tension is also applied to the follower tendon 530 connected to the slider 300. When the follower tendon 530 is pulled, the follower tendon 530 pulls the cap members 711 and 712 via the wrist member 720 of the glove member 700. As a result, the finger of the user wearing the glove member 700 is bent.

In this regard, since the follower tendon 530 is wound by the follower pulleys 521 and 522 and receives the tension while being able to be slipped by the follower bearings 511 and 512, the follower tendon 530 distributes the appropriate level of tension to each finger while distributing the appropriate level of tension to the cap members 711 and 712. For example, when the index finger is bent and contacts an object in the operation of holding the object, the follower tendon 530 slides with respect to the follower bearings 511 and 512 and pulls only the cap member 711 covering the middle finger. That is, the glove member 700 can be actuated only using one actuator (the actuation tendon 430), wherein the number of actuators is less than the number of fingers (two) to be actuated. In addition, unlike the conventional method, the slip of tendon occurs not in a globe but in a place where the operation of the follower tendon 530 occurs due to the follower pulleys 521 and 522 and the follower bearings 511 and 512. Accordingly, the follower tendon 530 does not substantially slip. By configuring the slip for under-actuation to occur only on the follower bearings 511 and 512, the friction force generated by the movement of the follower tendon 530 is drastically reduced. As a result, the glove-type wearable robot can be smoothly operated with relatively little actuation force, and the lifespan thereof can be prolonged.

In this state, when the actuation motor 410 is rotated in the opposite direction or the power of the actuation motor 410 is removed, the slider 300 may move to the right by the elastic force of the elastic member 600. As a result, the tension applied to the follower tendon 530 of the follower unit 500 is reduced, and the fingers of the user wearing the glove member 700 are also straightened out. Even at this time, the follower tendon 530 does not experience slip, and slip occurs only on the follower bearings 511 and 512. According to changes in the environment, such as changes in the force applied to the user's finger or the object being caught, the follower pulleys 521 and 522 may slip and rotate by the follower bearings 511 and 512, effectively transferring the tension required for under-actuation to the follower tendon 530.

In particular, when the follower unit 500 including a plurality of follower bearings 511 and 512 and a plurality of follower pulleys 521 and 522 as described above are used, the operation displacement of the follower tendon 530 can be increased only by the movement of the slider 300 with a relatively small displacement. Accordingly, the rapid operation of under-actuation devices such as the glove member 700 can be embodied. In addition, since a plurality of follower bearings 511 and 512 are used, the friction force caused by the movement of the follower tendon 530 may be further reduced and the operation may be performed more smoothly.

In addition, the actuation unit 400 that slides the slider 300 with respect to the guide member 200 may be configured in various forms. However, as in the present embodiment, in the case where the actuation motor 410 is used to rotate the actuation pulley 420 and the rotational movement of the actuation pulley 420 is converted to linear motion by the actuation tendon 430, the volume of the actuation unit 400 may be decreased. In addition, in the configuration of the mechanical element that converts rotational motion into linear motion in the actuation unit 400, as described above, when the actuation pulley 420 and the actuation tendon 430 wound around the actuation pulley 420 are used, compared to the case of using other configurations, such as a ball-screw, the manufacturing costs and volume can be significantly reduced.

Meanwhile, as described above, the follower unit 500 is provided detachably to the slider 300 by using the follower plate 570, and the connecting bearing 540 is provided detachably to the support body 100 using the connecting plate 560. Due to this structure, the follower unit 500 connected to the under-actuation robot including the glove member 700 may be conveniently separated or replaced from the slider-type wire driver for under-actuation.

As described above, embodiments of present disclosure have been described, but the scope of present disclosure is not limited to the described and illustrated embodiments.

For example, in the previous embodiments, the glove member 700 is connected with the slider-type wire driver for under-actuation. However, various other structures and forms of under-actuation robots than the glove member 700 can be connected to the slider-type wire driver for under-actuation of the present disclosure.

In addition, in the previous embodiments, the slider-type wire driver for under-actuation including the elastic member 600 and the glove-type wearable robot including the same have been described. However, a slider-type wire driver for under-actuation which does not an elastic member and a glove-type wearable robot, can also be configured.

In addition, the follower unit 500 has been described above as including a plurality of follower bearings 511 and 512 and a plurality of follower pulleys 521 and 522. However, in one or more embodiment, the slider-type wire driver for under-actuation may include one follower bearing and one follower pully.

In addition, in the previous embodiments, the follower unit 500 is detachably provided by using, for example, the follower plate 570. However, in one or more embodiment, a follower unit may be fixed on a slider.

1. A slider-type wire driver for under-actuation, comprising:
a support body;
a guide member provided on a support body to extend in a longitudinal direction of the guide member;
a slider provided on the guide member to be able to move linearly along the guide member;
an actuation unit provided on the support body to move the slider relative to the guide member; and
a follower unit including
at least one follower bearing provided on the slider,
a follower pulley provided on the follower bearing, and
a follower tendon provided to be wound around the follower pulley and having opposite ends connected to a device for actuation.

2. The slider-type wire driver of claim 1, wherein the actuation unit comprises:
an actuation motor, an actuation pulley connected to the actuation motor to rotate, and an actuation tendon having one end connected to the actuation pulley and the other end connected to the slider.

3. The slider-type wire driver of claim 1, further comprising
an elastic member provided onto the support body to provide an elastic force with respect to the slider in a direction opposite to the direction in which the slider is moved by the actuation tendon of the actuation unit.

4. The slider-type wire driver of claim 3, wherein the elastic member is a spring provided such that opposite ends thereof are connected to the slider and the support body, respectively.

5. The slider-type wire driver of claim 3, wherein the follower bearing of the follower unit is provided detachably to the slider.

6. The slider-type wire driver of claim 1, wherein the follower unit includes the follower bearing and the follower pulley, each in a plural number, wherein one follower tendon passes through the plurality of follower pulleys.

7. A glove-type wearable robot comprising a slider-type wire driver for under-actuation, the glove-type wearable robot comprising:
a support body;
a guide member provided on a support body to extend in a longitudinal direction of the guide member;
a slider provided on the guide member to be able to move linearly along the guide member;
an actuation unit provided on the support body to move the slider relative to the guide member; and
a follower unit including
at least one follower bearing provided on the slider,
a follower pulley provided on the follower bearing, and
a follower tendon provided to be wound around the follower pulley and having opposite ends connected to a device for actuation; and
a glove member that is formed in the form of a wearable glove and operates by being connected to each of the opposite ends of the follower tendon of the follower unit to each other.

8. The glove-type wearable robot of claim 7, wherein the glove member comprises:
two cap members formed to surround tips of different fingers, each of the two cap members being connected to opposite ends of the follower tendon of the follower unit; a wrist member which is mounted on a user's wrist and through which the follower tendon passes; and a tube member which is disposed between the two cap members and the wrist member and through which the follower tendon passes.

9. The glove-type wearable robot of claim 7, wherein the actuation unit comprises:
an actuation motor,
an actuation pulley connected to the actuation motor to rotate, and an actuation tendon having one end connected to the actuation pulley and the other end connected to the slider.

10. The glove-type wearable robot of claim 7, further comprising
an elastic member provided onto the support body to provide an elastic force with respect to the slider in a direction opposite to the direction in which the slider is moved by the actuation tendon of the actuation unit.

11. The glove-type wearable robot of claim 10, wherein the elastic member is a spring provided such that opposite ends thereof are connected to the slider and the support body, respectively.

12. The glove-type wearable robot of claim 10, wherein the follower bearing of the follower unit is provided detachably to the slider.

13. The glove-type wearable robot of claim 7, wherein the follower unit includes the follower bearing and the follower pulley, each in a plural number, wherein one follower tendon passes through the plurality of follower pulleys.
